(19) United States
(12) Patent Application Publication
(10) Pub. No.: US 2009/0256832 A1
(43) Pub. Date: Oct. 15, 2009

(54) METHOD AND A DEVICE FOR DRIVING LIQUID CRYSTAL DISPLAY

(76) Inventor: Yue DING, Beijing (CN)

Correspondence Address: LADAS & PARRY LLP, 224 SOUTH MICHIGAN AVENUE, SUITE 1600, CHICAGO, IL, 60604, US

(21) Appl. No.: 12/421,966

(22) Filed: Apr. 10, 2009

(30) Foreign Application Priority Data
Apr. 14, 2008 (CN) 200810104044.3

(51) Int. Cl. G09G 5/00

(52) U.S. Cl. 345/211

(57) ABSTRACT

The present invention relates to a method and a device for driving liquid crystal display. The method comprises: turning on the N-th row of gate line; closing a switch, so that the charges on the two rows of gate line are neutralized and the gate ON voltage on the N-th row of gate line is reduced to a secondary ON voltage for gate; and turning off the N-th row of gate line. The device comprises a liquid crystal panel, a gate driver and a data driver, wherein the liquid crystal panel is disposed with a gate line connected with the gate diver as well as a data line connected with the data drivel, and a controlling device for enabling charge-sharing on adjacent gate lines is connected between the adjacent gate lines. In the present invention, by adding a switch between two rows of gate line, the gate line currently being turned on is short-circuit with the next row of gate line, so that the charges on the two rows of gate line are neutralized, a secondary ON voltage is generated, and multi-level gate voltage is achieved, thus effectively solving the technical defects in the present LCD, that is, an increase in the current consumption of the whole driving circuit and an increase in cost that are caused when adding a circuit for modulating multi-level gate ON voltage on a gate driving circuit board.

### FIELD OF THE INVENTION

The present invention relates to the field of liquid crystal display, a method and a device for driving liquid crystal display.

### BACKGROUND OF THE INVENTION

In recent years, liquid crystal display (LCD) products develop very rapidly, an increasing number of high quality thin film transistor (TFT) LCD gradually comes into market, and the field of its application is becoming broader.

TFT LCD controls the turning ON and OFF of the transistor by driving the gate of thin film transistor. Such gate driving method uses a way of progressive scanning, and when a certain row of gate line turns on, the other rows of gate line are at OFF state. FIG. 6A is a structural schematic diagram of gate output terminal of a single gate ON voltage according to the prior art, and FIG. 6B is a schematic diagram of gate output of a single gate ON voltage according to the prior art. As shown in 6A and 6B, when the N-th row of gate line is required to turn on, gate ON voltage Von is inputted to the N-th row of gate line, while gate OFF voltage Voff is inputted to the (N+1)-th row of gate line and the other rows of gate line, thus they are at OFF state. When the N-th row of gate line turns off, the (N+1)-th row of gate line turns on and outputs ON voltage Von, while gate OFF voltage Voff is inputted to the N-th row of gate line and the other rows of gate line. Since the parasitic capacitance exists on the thin film transistor, when the gate OFF voltage Voff is inputted to the gate, the generated feedthrough voltage will affect the hold of the charge on the pixel capacitor, thus causing the LCD flickering. In order to reduce the LCD flickering due to feedthrough voltage, a method of multi-level gate is used, in which gate ON voltage is modulated by adding a circuit for modulating multi-level gate ON voltage on a driving circuit board, that is, adding a secondary ON voltage on the gate ON voltage. Then the gate ON and OFF voltages are used as the input to the gate driver, and a multi-level gate driving voltage is outputted by a gate driver. Practical application shows that, in one hand, such method of adding a circuit for modulating multi-level gate ON voltage on a driving circuit board increases the cost of the driving circuit board, and in the other hand, the circuit for modulating the multi-level gate ON voltage needs to consume extra current and also increases the current consumption of the whole driving circuit.

### SUMMARY OF THE INVENTION

Embodiments of the present invention provide a method and a device for driving LCD, which effectively solve the technical defects in the present LCD, that is, an increase in the current consumption of the whole driving circuit and an increase in cost that are caused when adding a circuit for modulating multi-level gate ON voltage on a gate driving circuit board.

An embodiment of the present invention provides a method for driving LCD, comprising the following step:

step 1 of inputting a gate ON voltage to the N-th row of gate line so as to turn on the N-th row of gate line;

step 2 of closing a switch between the N-th row of gate line and the (N+1)-th row of gate line after a first set time, so that the N-th row of gate line and the (N+1)-th row of gate line are connected, charges on these two rows of gate line are mutually neutralized and the gate ON voltage on the N-th row of gate line is reduced to a secondary ON voltage for the gate; and

step 3 of opening said switch after a second set time, and inputting the gate OFF voltage to the N-th row of gate line so as to turn off the N-th row of gate line.

An embodiment of the present invention also provides a device for driving LCD, comprising a liquid crystal panel, a gate driver and a data driver, wherein said liquid crystal panel is disposed with a gate line connected with said gate diver as well as a data line connected with said data driver, and a controlling device for enabling charge-sharing on adjacent gate lines is connected between the adjacent gate lines

The controlling device is connected with the gate driver, and the gate driver controls the controlling device to close after the gate has been ON for the first set time and open after the second set time.

The controlling device is a switch.

An embodiment of the present invention adds a switch between two rows of gate line, and when the secondary ON voltage is required, the gate line currently being opened Lip is short-circuit with the next row of gate line, so that the charges on the two rows of gate line are neutralized, the voltage of the gate line that is at ON state is reduced to a half of the original full ON voltage, and multi-level gate voltage is achieved, thus effectively solving the technical defects in the present LCD, that is, an increase in the current consumption of the whole driving circuit and an increase in cost that are caused when adding a circuit for modulating multi-level gate ON voltage on a gate driving circuit board.

The technical solutions of the embodiments of the present invention will be further described in detail below with reference to accompanying drawings and embodiments.

### BRIEF DESCRIPTION OF THE DRAWINGS

FIG. 1 is a flowchart of a method for driving LCD according to an embodiment of the present invention;

FIG. 2A is a timing chart for implementing control with the method for driving LCD according to an embodiment of the present invention;

FIG. 2B is a structural diagram of a gate driver controlling circuit for implementing the timing of FIG. 2A;

FIG. 3 is a structural schematic diagram of gate output terminal of a device for driving LCD according to an embodiment of the present invention;

FIG. 4A is a structural diagram of the output terminals of the N-th row and the (N+1)-th row of gate line at the time T1, in the device for driving LCD according to an embodiment of the present invention;

FIG. 4B is a structural diagram of the output terminals of the N-th row and the (N+1)-th row of gate line at the time T2, in the device for driving LCD according to an embodiment of the present invention,

FIG. 4C is a schematic diagram of the output terminal of the N-th row of gate line at the time T1, in the device for driving LCD according to an embodiment of the present invention;

FIG. 4D is a schematic diagram of the output terminal of the (N+1)-th row of gate line at the time T1, in the device for driving LCD according to an embodiment of the present invention;

FIG. 4E is a schematic diagram of the output terminal of the N-th row of gate line at the time T2, in the device for driving LCD according to an embodiment of the present invention;

FIG. 4F is a schematic diagram of the output terminal of the (N+1)-th row of gate line at the time T2, in the device for driving LCD according to an embodiment of the present invention;

FIG. 5A is a timing chart when the signal OE is used as a switch control signal, in the device for driving LCD according to an embodiment of the present invention;

FIG. 5B is a schematic diagram of the output terminals of the N-th row and the (N+1)-th row of gate line, when the signal OE is used as a switch control signal, in the device for driving LCD according to an embodiment of the present invention;

FIG. 6A is a structural schematic diagram of gate output terminal of a single gate ON voltage according to the prior art; and

FIG. 6B is a schematic diagram of gate output of a single gate ON voltage according to the prior art.

### DESCRIPTION OF THE PREFERRED EMBODIMENTS

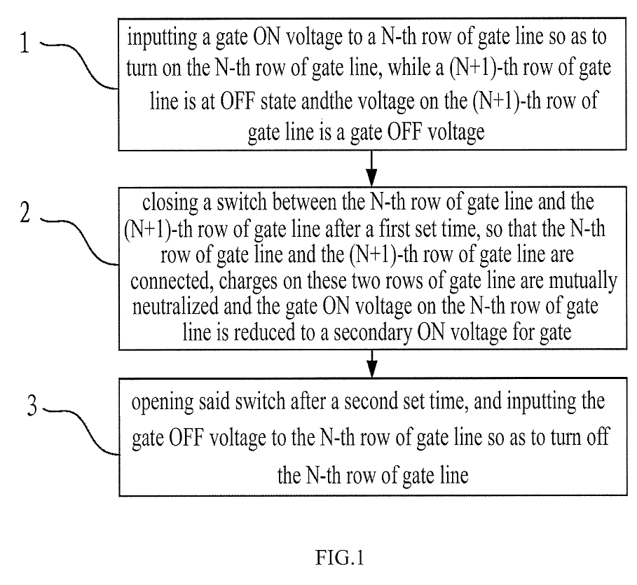

FIG. 1 is a flowchart of a method for driving LCD according to an embodiment of the present invention. As shown in FIG. 1, the method for driving LCD according to an embodiment of the present invention comprises the following steps:

step 1 of inputting a gate ON voltage to a N-th row of gate line so as to turn on the N-th row of gate line, while a (N+1)-th row of gate line is at OFF state and the voltage on the (N+1)-th row of gate line is a gate OFF voltage;

step 2 of closing a switch between the N-th row of gate line and the (N+1 )-th row of gate line after a first set time, so that the N-th row of gate line and the (N+1)-th row of gate line are connected, charges on these two rows of gate line are mutually neutralized and the gate ON voltage on the N-th row of gate line is reduced to a secondary ON voltage for gate; and

step 3 of opening said switch after a second set time, and inputting the gate OFF voltage to the N-th row of gate line so as to turn off the N-th row of gate line.

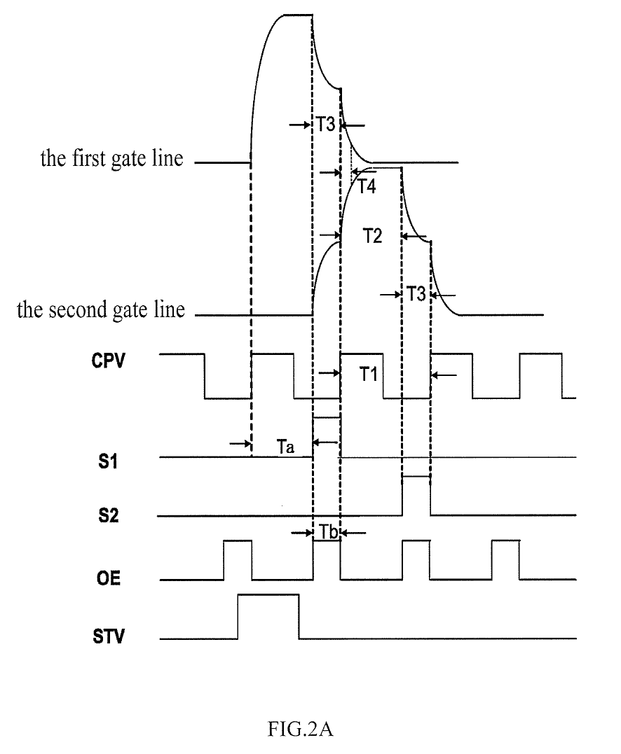

FIG. 2A is a timing chart for implementing control with a method for driving LCD according to an embodiment of the present invention. As shown in FIG. 2A, STV is an ON signal for rows, CPV is a clock signal for rows, S1 is a switch control signal between the a first row of gate line and a second row of gate line, OE is a clock signal for the switch, the first gate line is the output of the first row of gate line, and the second gate line is the output of the second row of gate line. When STV is at high level, that is, a high voltage is applied to gate line, the gate line turns on and begins to output. When a first rising edge of CPV arrives, the first row of gate line turns on. Thereafter, when a first rising edge of OE arrives (that is, a first set time Ta has elapsed), the switch S1 is closed, thus charge-sharing starts between the first row of gate line and the second row of gate line. When a falling edge of OE arrives (that is, a second set time Tb has elapsed), the switch S1 is opened, and the charge-sharing is completed. At the same time, CPV is increased and the first row of gate line turns off. When a second rising edge of CPV arrives, the second row of gate line turns on, and when a rising edge of OE arrives, the switch S2 is closed, thus the charge-sharing starts between the second row of gate line and the third row of gate line. When a falling edge of OE arrives, the switch S2 is opened, and the charge-sharing is completed. At the same time, CPV is increased, the second row of gate line turns off and the third row of gate line turns on. It is repeated in this way until the final row of gate line turns off. Wherein, since there is no previous row of gate line for the first row of gate line to share charge therewith, the waveform thereof is different from the other rows of gate line.

In FIG. 2A, T1 is an ON time for the gate line without charge-sharing in ideal condition (that is, the load of gate line is 0), duration thereof is approximately on the order of tens of microseconds, which equals to 1/(the total number of rows×the number of frames), depending on the characteristic of the specific panel. T3 is a time for charge-sharing, that is, the time during which the voltage of gate line is reduced to a secondary ON voltage for the gate when the gate line is turned off in advance. The duration of this time is approximately on the order of several microseconds and is much smaller than T1. When the charge-sharing is performed, the generated voltage will be lower than the ON voltage of the gate line, which can be considered as an incomplete OFF state. Therefore, when the charge-sharing is used, the full ON time for gate line is T2, which is shorter by T3 than the full ON time for gate line when the charge-sharing is not used, and this time is approximately on the order of tens of microseconds and is slightly shorter than T1. It is the same as the conventional method of generating a multi-level gate ON voltage with an external circuit in that at the time of designing, the reduced time T3 due to the turning on of the gate line which influences the pixel charging should also be considered. Generally, the time from loading the data voltage to turning off the gate line (that is, the time from loading 1% of the voltage to 99% of the voltage) is considered as the charging time for the pixel. During this charging time, the pixel being charged to 99% is considered as being fully charged. At the time of designing, T3 should be set to an appropriate time, so as to ensure that it is charged sufficiently. In non-ideal conditions, a load exists on the gate line, and the time for turning on gate line will be delayed by T4, which is the delay resulting from the panel load, and is approximately on the order of several microseconds, much smaller than the time T1 for turning on the gate line. Thus the full ON time for gate line is reduced by T2-T4. It should be ensured that the pixel is fully charged in this condition, and then the display effect will not be influenced.

FIG. 2B is a structural diagram of a gate driver controlling circuit for implementing the timing of FIG. 2A. As shown in FIG. 2B, wherein CPV is a clock pulse signal for the gate line, STV is a signal for turning on the first gate line, and OE is a clock pulse signal for controlling the charge-sharing. Shift register is a circuit for selecting the register one by one according to the input clock. Level shift circuit is a circuit for increasing an input level to order of an output level. Output circuit outputs the generated level to the panel. After a first shift register receives the input STV signal, each unit of the level shift circuit is selected one by one according to the clock pulse signal of CPV. The selected unit will increase the level to the required output level which is sent to output circuit to output. After a second shift register receives the input STV signal, the turning on and off of switches for the charge-sharing between the adjacent gate lines are controlled by the clock pulse signal OE. STV, CPV and OE are performed at the timing of FIG. 2A so as to implement the function of charge-sharing.

The embodiment of the present invention adds a switch between the two rows of gate line, and when a secondary ON-voltage is required, the gate line currently being turned on is short-circuit with the next row of gate line, so that the charges on these two rows of gate line neutralized, the voltage of the gate line that is at ON state is reduced to a half of the original full ON voltage, and a multi-gate gate voltage is achieved, thus while the current required for modulating a multi-level gate ON voltage circuit (about 100 mA) is saved, while the current required for turning on the gate gradually is also saved, thereby effectively solving the technical defects in the present LCD, that is, an increase in the current consumption of the whole driving circuit and an increase in cost that are caused when adding a circuit for modulating multi-level gate ON voltage on a gate driving circuit board.

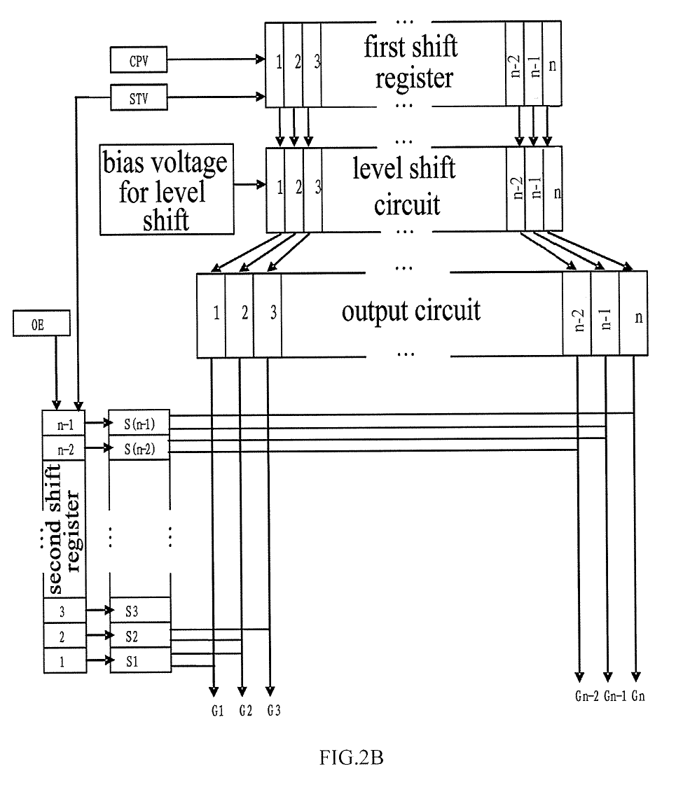

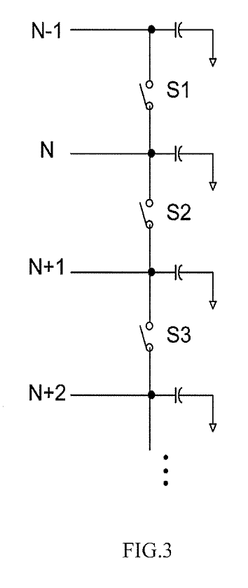

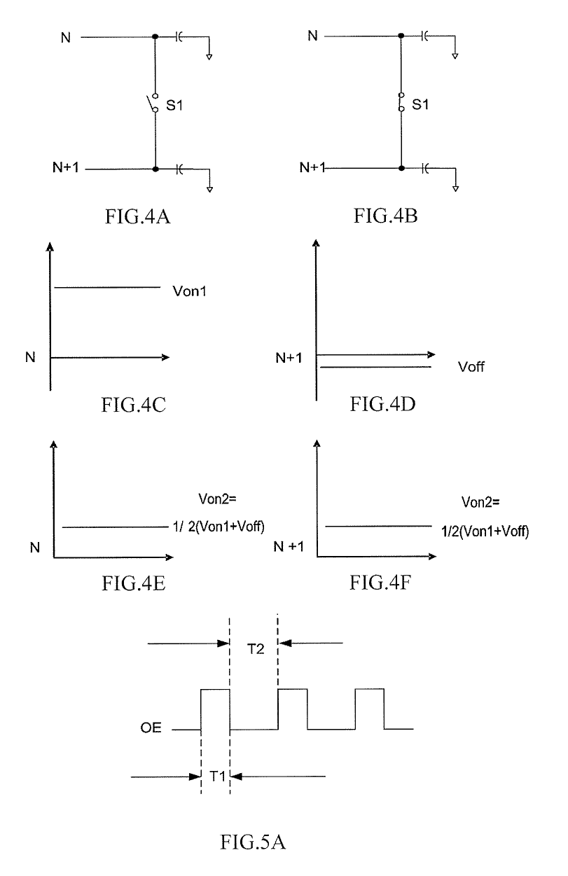

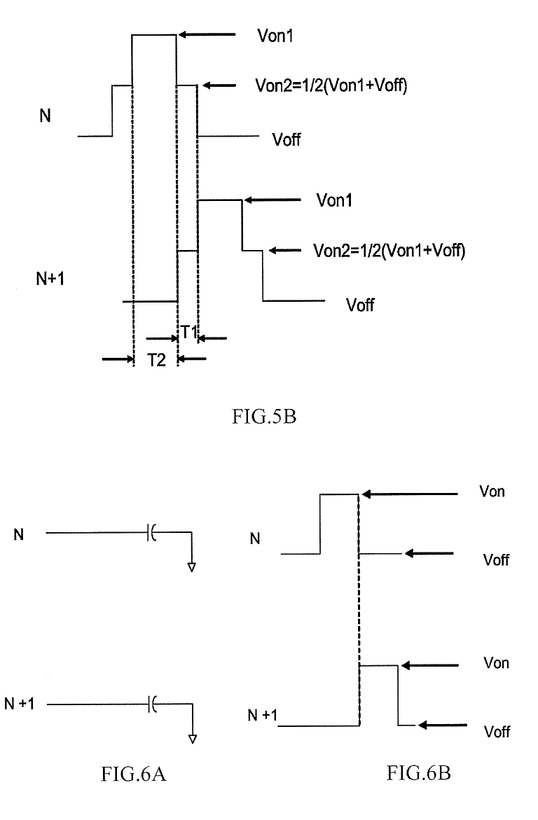

FIG. 3 is a structural schematic diagram of gate output terminal of a device for driving LCD according to an embodiment of the present invention. As shown in FIG. 3, an embodiment of the present invention provides a device for driving LCD, comprising a liquid crystal panel, a gate driver and a data driver. The liquid crystal panel comprises gate lines, data lines and a controlling device. The gate driver is connected with the gate lines and used to drive the gate lines. The data driver is connected with the data lines and used to drive the data lines. The controlling device is connected between the adjacent gate lines and also connected with the gate driver, and used to enable the charge-sharing on the adjacent gate lines. The gate driver controls the control device to be closed after the gate is turned on for a first set time, and to be closed after a second set time. In the present embodiment, the control device uses signal OE as the switch for control signal. FIG. 4A is a structural diagram of the output terminals of the N-th row and the (N+1)-th row of gate line at the time T1, in the device for driving LCD according to an embodiment of the present invention. As shown in FIG. 4A, the switch S1 is in open state at the time T1. FIG. 4C is a schematic diagram of the output terminal of the N-th row of gate line at the time T1, in the device for driving LCD according to an embodiment of the present invention. FIG. 4D is a schematic diagram of the output terminal of the (N+1)-th row of gate line at the time T1, in the device for driving LCD according to an embodiment of the present invention. As shown in FIGS. 4C and 4D, at the time T1, the N-th row of gate line outputs ON voltage Von1, and the (N+1)-th row of gate line outputs OFF voltage Voff. FIG. 4B is a structural diagram of the output terminals of the N-th row and the (N+1)-th row of gate line at the time T2, in the device for driving LCD according to an embodiment of the present invention. As shown in FIG. 4B, the switch is closed at the time T2, that is the time when it needs to output a secondary ON voltage. FIG. 4E is a schematic diagram of the output terminal of the N-th row of gate line at the time T2, in the device for driving LCD according to an embodiment of the present invention. FIG. 4F is a schematic diagram of the output terminal of the (N+1)-th row of gate line at the time T2, in the device for driving LCD according to an embodiment of the present invention. As shown in FIGS. 4E and 4F, at the time T2, the N-th row of gate line and the (N+1)-th row of gate line are short-circuit, and the charges on these two rows of gate line are neutralized mutually, thus the ON voltage is reduced to a half of the sum of the ON and OFF voltages, that is the secondary ON voltage. FIG. 5A is a timing chart when the signal OE is used as a switch control signal, in the device for driving LCD according to an embodiment of the present invention. FIG. 5B is a schematic diagram of the output terminals of the N-th row and the (N+1)-th row of gate line, when the signal OE is used as a switch control signal, in the device for driving LCD according to an embodiment of the present invention. As shown in FIGS. 5A and 5B, when the OE is at low level, the switch is opened, the adjacent two gate lines are open-circuit, thus the charge-sharing is not performed at the time T2. When the OE is at high level, the switch is closed, the adjacent two gate lines are short-circuit, thus the charge-sharing is performed at the time T1. When the charge-sharing is performed, since the capacitance of capacitors on the adjacent two rows of gate lines N and N+1 are same, the charge will be equally distributed on these two capacitors. From Q=C×V, Q1=C×Von1 and Q2=C×Voff, Q3=1/2×C×(Von1+Voff) can be derived, wherein Q1 is the charge on the capacitor of gate line N before the charge-sharing, Q2 is the charge on the capacitor of gate line N+1 before the charge-sharing, and Q3 is the charge on gate lines N and N+1 after the charge-sharing. Thus it can be obtained that the secondary ON voltage Von2=1/2×(Von1+Voff).

The embodiment of the present invention adds a switch between the two rows of gate line, and when a secondary ON-voltage is required, the gate line currently being turned on is short-circuit with the next row of gate line, so that the charges on these two rows of gate line neutralized, the voltage of the gate line that is at ON state is reduced to a half of the original full ON voltage, and a multi-gate gate voltage is achieved, thus effectively solving the technical defects in the present LCD, that is, an increase in the current consumption of the whole driving circuit and an increase in cost that are caused when adding a circuit for modulating multi-level gate ON voltage on a gate driving circuit board.

Finally, it should be noted that the above embodiments is only for explaining the technical solution of the present invention, and not for limitation. Although the present invention has been described in details with reference to the preferred embodiments, those skilled in the art should be appreciated that the technical solutions of the present invention can be modified or equivalently replaced without departing from the spirit and scope of the technical solution of the present invention.

What is claimed is:

1. A method for driving liquid crystal display, comprising the following steps:
step 1 of inputting a gate ON voltage to a N-th row of gate line so as to turn on the N-th row of gate line, while a (N+1)-th row of gate line is at OFF state and the voltage on the (N+1)-th row of gate line is a gate OFF voltage;
step 2 of closing a switch between the N-th row of gate line and the (N+1)-th row of gate line after a first set time, so that the N-th row of gate line and the (N+1)-th row of gate line are connected, charges on these two rows of gate line are mutually neutralized and the gate ON voltage on the N-th row of gate line is reduced to a secondary ON voltage for gate; and
step 3 of opening said switch after a second set time, and inputting the gate OFF voltage to the N-th row of gate line so as to turn off the N-th row of gate line.

2. A device for driving liquid crystal display, comprising a liquid crystal panel, a gate driver and a data driver, said liquid crystal panel being disposed with a gate line connected with said gate driver as well as a data line connected with said data driver, a controlling device for enabling charge-sharing on the adjacent gate lines is connected between the adjacent gate lines.

3. The device for driving liquid crystal display according to claim 2, the controlling device is connected with the gate driver, the gate driver controls the controlling device to close after the gate has been ON for the first set time and open after the second set time.

4. The device for driving liquid crystal display according to claim 2, the controlling device is a switch.

5. The device for driving liquid crystal display according to claim 3, the controlling device is a switch.
